(19) United States
(12) Patent Application Publication
(10) Pub. No.: US 2009/0281272 A1
(43) Pub. Date: Nov. 12, 2009

(54) Monodisperse Molecularly Imprinted Polymer Beads

(75) Inventors: Ecevit Yilmaz, Bjarred (SE); Anthony Rees, Furulund (SE)

Correspondence Address: SCHWEGMAN, LUNDBERG & WOESSNER, P.A., P.O. BOX 2938, MINNEAPOLIS, MN, 55402, US

(73) Assignee: MIP Technologies AB, Lund (SE)

(21) Appl. No.: 12/086,137

(22) PCT Filed: Dec. 6, 2006
(86) PCT No.: PCT/SE2006/050554

§ 371 Date: Apr. 15, 2009

(30) Foreign Application Priority Data
Dec. 7, 2005 (SE) 0502700-8
May 12, 2006 (SE) 0601066-4

(51) Int. Cl. C08G 69/26

(52) U.S. Cl. 528/332

(57) ABSTRACT

The invention relates to a molecularly imprinted polymer resin characterized by a monodisperse size distribution prepared by forming monomer droplets via a membrane, polymerizing said droplets in an appropriate continuous phase, and harvesting the resulting polymer particles. The invention also relates to a method for producing a molecularly imprinted polymer resin, wherein a monomer solution is forced through a dispersing device capable of forming small droplets, the droplets are projected into a continuous phase in which a polymerization is initiated leading to solidification of the droplets into beads.

### BACKGROUND ART

Molecularly imprinted polymers (MIPs) were first described in the 1970's (Wulff & Sarhan, Angewandte Chemie, 84, 364, 1972). They were produced by a concentrated solvent polymerization to yield monolithic polymer blocks. These monoliths were usually mechanically disintegrated by grinding and then separated into desired particle size populations by fractionation steps. Due to the nature of crude grinding and sieving procedures leading to a broad particle size spectrum, the yields for a given particle size range were moderate to low (e.g. from 25-50% for a particle size range of 10-25 μm). This method for making MIPs by a concentrated solution polymerization process was known not to be applicable to batch sizes larger than 100 ml per reaction batch. The reason is that the amount of heat generated during larger scale polymerizations of this type cannot easily be removed, effectively precluding this approach from production of the large amounts of MIP material, required for preparative, process or industrial scale applications.

Typically molecularly imprinted polymers (MIPs) are produced by polymerizing monomers and cross-linkers in presence of a template in a solvent. After polymerization, the template is washed out to leave behind binding sites within the polymer, wherein the template and similar molecules can rebind with a certain specificity. Mosbach discloses in U.S. Pat. No. 5,110,833 how MIPs are produced for use in enzymatic or affinity applications. MIPs can be made towards many different targets and they display many different selectivities, such as those summarized in the textbook edited by Sellergren (Sellergren, B, Molecularly Imprinted Polymers: Man made mimics of antibodies and their application in analytical chemistry. B. Sellergren (Ed.) Elsevier publishers, 2001). Traditionally a molecularly imprinted polymer has been prepared as follows: A template, for example propranolol or theophylline, a functional monomer, e.g. methacrylic acid, a crosslinker, e.g. ethyleneglycol methacrylate or divinylbenzene and an initiator, e.g. azoisobutyronitrile are dissolved in an organic solvent, such as chloroform, toluene or acetonitrile. After complete dissolution of all components, the solution is polymerized. After polymerization, the obtained polymer block is ground and sieved and then extensively washed with for example methanol and acetic acid. Depending on grinding and sieving, various particle size ranges may be obtained. Typically, such particles are ground to a fine powder. The thus obtained particles have a broad particle size distribution and are of granular shape, they are not spherical. The particles have to be sieved to obtain particle classes that are free of undesired fine particles (smaller than 20 μm) and large particles (larger than 90 μm) in order to obtain a class of particles in the size range 20-90 μm. Usually, by grinding and sieving the yield of particles of the desired size range of 20-90 μm is in the order of only 50% as the other 50% represent fine or large particles.

In 1994, Sellergren (Sellergren, Journal of Chromatography A, 1994, 673, 133-141) devised a method to produce imprinted beads by a dispersion method to yield discrete imprinted particles. These particles were obtained by a modification of the monomer concentration in the porogen from the typical value of around 50% to around 20%. This change (i.e. lowering the monomer concentration) altered the nature of the network formation of the growing polymer microgel particles. Aggregates of microgel particles of below 10 μm were obtained although the aggregates were of irregular nature in both size and shape.

A further development of this approach, a precipitation polymerization approach was described by Ye et al (Ye, Cormack & Mosbach, Analytical Communications, 1999, 36, 35-38). In this work, the monomer concentration in the solvent was lowered further (<20%) to yield non-agglomerated microgel particles in the sub-micrometer size range. Although the particles were monodisperse and spherical, their small size made them inappropriate for many chromatographic processes and hence excludes them from most applications in the separations area. The method of precipitation polymerization cannot be modified or controlled sufficiently to generate larger, more useful particle sizes.

Suspension polymerization is a further method that yields polymer beads that are spherical and whose size can be influenced by engineering adjustments in both the reactor and stirrer geometry and by varying the composition of the suspended mixture, such as the ratio of dispersed to continuous phase and the presence or absence of various additives. In a further development of the suspension method Mosbach et al (Mayes & Mosbach, Analytical Chemistry, 1996, 68, 3769-3774) described a method of producing MIP particles by using a perfluorocarbon as a continuous phase. This ‘inverse suspension’ system was developed in order to avoid water as the continuous phase in situations where it might interfere with the self-assembly of hydrophilic functional monomers and/or template molecules. However, several of its required process parameters preclude its practical use for large-scale production methods. For example, perfluorocarbon solvents are highly priced and may be toxic to humans or the environment in which case their use in large scale production should be avoided. Another limitation of this approach is that special and high cost fluorinated surfactants additives are required to yield discrete polymer particles. Finally, as in all suspended polymer resins so far described, the particle size distribution is polydisperse and would require sieving to yield particles with discrete size ranges. Given the nature of stirred systems and the turbulent conditions typical in a stirred phase, polydispersity of the particle sizes is likely.

Kempe (Kempe & Kempe, Macromolecular Rapid Communications, 2004, 25, 314-320) recently described a further suspension polymerization system in which the suspension was also performed in an “inverse mode” and where relatively polar MIP monomers (and hence likely to be soluble in water) were dispersed in a mineral oil continuous phase. One advantage of this process is that mineral oil is an inexpensive alternative to fluorinated solvents. A key disadvantage is that several important MIP porogens are soluble in mineral oil and cannot be used in this process. In addition, this suspension polymerization method also leads to heterogeneous particle size distributions.

A further method recently described involves the use of emulsion polymerization to produce dispersed MIP particles. The group of Tovar (Vaihinger et al., Macromolecular Chemistry and Physics, 2002, 203, 1965-1973) developed a method of “imprinted lattices” obtained by an emulsion process. A detergent emulsified the non-miscible phases and formed micelles of monomers in the aqueous phase, polymerization of which was then initiated from the water phase. The particles obtained from this approach were, depending on the chemistry, in the nanometer range. Again, the very small sizes of such particles preclude their use in typical separations materials (e.g. in chromatography).

Other examples in the prior art describe the production of imprinted beads within an aerosol phase (Vorderbruggen et al, Chemistry of Materials, 1996, 8, 1106-1111). In this example the monomers are required to polymerize extremely quickly since the polymerization occurs in the gas or vapour phase. Only a few special monomers based on silanes are known to have this capability rendering the system limited utility. No further reports using this specific methodology have been described to the best of our knowledge.

Tepper et al (WO02059184 A2) utilized a similar approach in which very small beads are formed via an aerosol of a monomer solution. The aim was to deposit the monomer solution on support materials that are then either used in sensing devices or for other selective recognition purposes. The particle size is below 100 μm, is polydisperse and the method is said to display a preference for particles at the lower end of the size range.

### SUMMARY OF THE INVENTION

The present invention provides methods and procedures for the production of spherical, monodisperse molecularly imprinted polymer beads that can be produced in small and large scale quantities by the use of controlled pore membranes.

The object of the present invention is to prepare a molecularly imprinted polymer resin that have improved properties, compared to commonly used materials, and wherein the resin according to the present invention displays a highly uniform size distribution of the bead particles. The present invention can used be e.g. in separations, filters or other processes. The object of the present invention is achieved by a membrane emulsification process that leads to droplets and thus molecularly imprinted polymer beads of uniform size and shape.

The object of the present invention may be achieved by forming droplets of an imprinting mixture using a controlled pore sized membrane, wherein the droplets are formed in a continuous phase in which the imprinting mixture has a low solubility, and wherein said monodisperse molecularly imprinted polymer bead particles are formed by:
a) providing a continuous phase,
b) providing at least one monomer and at least one template, optionally in a solvent, forming an imprinting mixture, being mainly immiscible in said continuous phase,
c) providing a porous membrane, separating said continuous phase and said imprinting mixture,
d) allowing said imprinting mixture to pass through said porous membrane, forming droplets in said continuous phase,
d) polymerizing said imprinting mixture,
e) removing said continuous phase and said template to obtain said molecularly imprinted polymer resin.

The molecularly imprinted resin according to the invention provides several improvements compared to the above mentioned prior art, i.e. broad particle size distribution, granular shape, and low yield of the above described synthesis process (monolith approach) in which polymer grinding leads to non-uniform granules of varying size and shape (poor particle morphology), and involves laborious work-up steps and leads to poor control of process parameters and low yield.

### BRIEF DESCRIPTION OF THE FIGURES

FIG. 1. Illustrates an example of the present invention. A membrane, nozzle array or whole plate is used to disperse the monomer droplets into the continuous phase and harvested at the bottom.

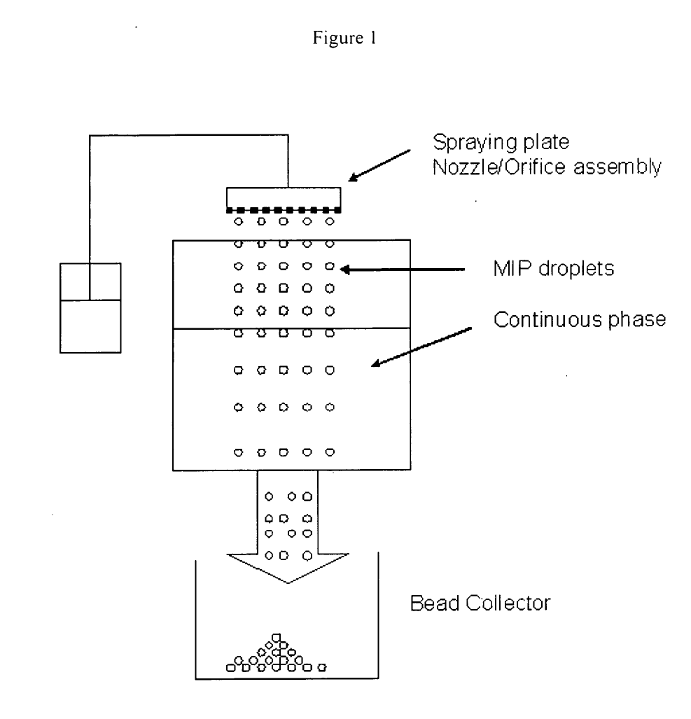

FIG. 2. Illustrates an example of the present invention. A membrane or whole plate is used to disperse the monomer droplets into the continuous phase which is stirred.

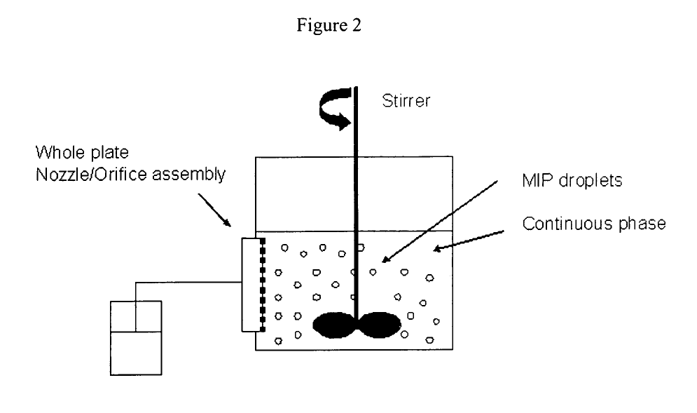

FIG. 3. Illustrates across-flow example of the present invention. A membrane or whole plate is used to disperse the monomer droplets into the continuous phase. Droplets formed are scoured with the flow of the continuous phase. This method allows the continuous production of monodisperse beads in a wide range of sizes. There are several differing potential locations of such dispensing devices. They can be placed on the top, on the side or at the bottom of a reaction chamber.

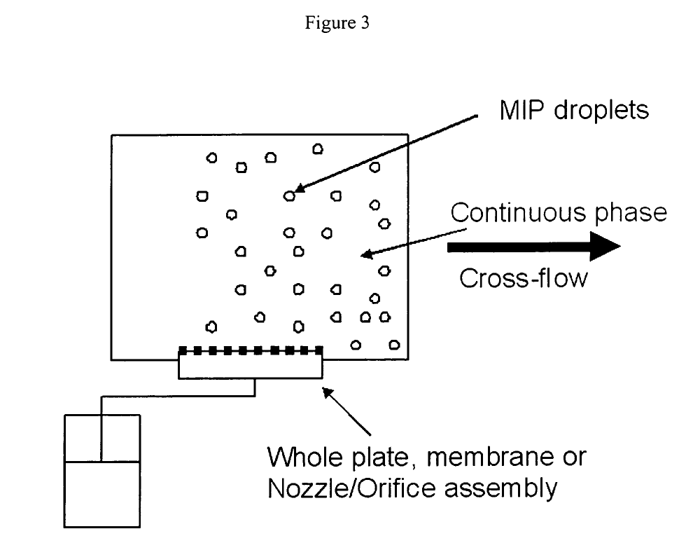

FIG. 4. Illustrates a cross-flow example of the present invention. A hollow membrane is used to disperse the monomer droplets into the flow (e.g. Shirasu glass membrane, porous ceramic material or similar). This method allows the continuous production of monodisperse beads having wide size range.

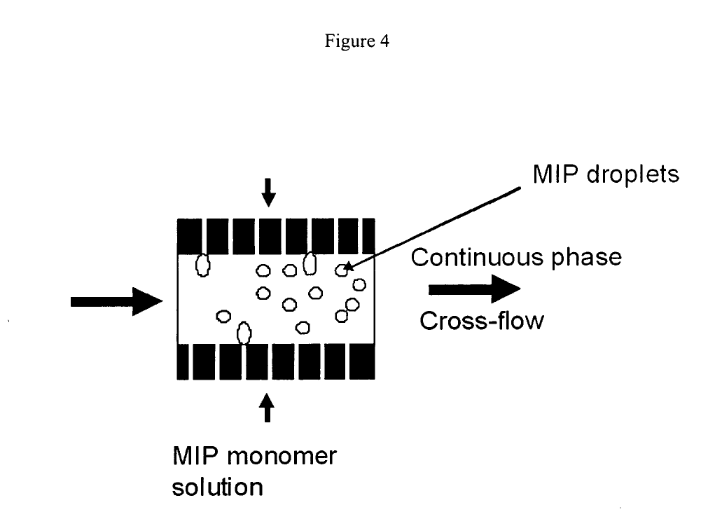

### DETAILED DESCRIPTION OF THE PREFERRED EMBODIMENTS

The present invention and its methodology correspond to the following steps: A molecular imprinting monomer solution is forced through a dispersing device capable of forming small droplets. Such a device could be a membrane, e.g. Shirasu glass membrane, porous ceramic material or similar. These droplets are projected into a continuous phase in which a polymerization is initiated leading to solidification of the beads. At the end of the process the polymer beads are collected and harvested. The monomer solution can be dispensed to form small droplets in a variety of ways: by a designed hole-plate containing appropriate microchannels, or a large array of optimized nozzles or small orifices, or by a piezoelectric dispensing device, or by a Shirasu Porous Glass (SPG) membrane, porous ceramic membranes or membranes having similar function or derivatives thereof. Any of these methods, or derivatives of them, can be used to form a continuous flow or spray of liquid MIP monomers that enters into a liquid (continuous phase) in which the monomer solution is either insoluble or shows low solubility. In a further embodiment, the continuous phase can be engineered to exhibit a high viscosity or to contain protective agents, that may, for example, envelop or encapsulate the entering monomer droplets and thus protect the formed bead. The transfer of the monomer liquid from the dispensing device into the continuous phase is done by gravity from the top passing through air or by an inert gas and then into the continuous phase, or it may be done from a designated region of a reactor which carries out the dispensing directly into the continuous phase. Preferably, the monomer droplets are dispersed into the continuous phase by a membrane technique and scoured via a cross-flow.

In one embodiment according to the present invention, a monomer mixture is prepared, comprising at least one monomer, at least one crosslinker, at least one template and optionally a porogen. A continuous phase, in which said imprinting mixture is mainly immiscible, is provided, said continuous phase being either an aqueous continuous phase or an organic continuous phase, both optionally containing additives. Non limiting examples thereof are water optionally containing a suspension stabilizer or an emulsifier, or a mineral oil, optionally containing a suspension stabilizer or an emulsifier. Additionally other additives known to a person skilled in the art may be used, such as emulsifiers or suspension stabilizers, e.g. polyvinyl alcohol, Span 80 and Tween 20, which are commercially available from Sigma-Aldrich, or Pluronic available from BASF Company, and sodium dodecylsulfate (SDS). The monodisperse imprinted resin according to the present invention is obtainable by using a dispensing device (e.g. Mini kit K-125 from SPG Technology, Japan), wherein said dispensing device must comprise a membrane, which is capable of controlling the formation of droplets, i.e. formation of droplets of the monomer mixture. The monomer mixture is pressed through a controlled pore membrane into the continuous phase after which the continuous phase containing the monomer droplets of the mixture is polymerized. Polymerization of the droplets, formed by passing the monomer mixture through the above mentioned membrane in said dispensing device, leads to monodisperse imprinted polymer particles.

As described in the prior art, a molecularly imprinted polymer can be designed, synthesized and applied to a vast variety of target molecules that can vary from very small entities such as metal ions to larger entities such as bacteria. However, the majority of prior art in molecular imprinting is reported to work best with small organic molecules that originate from the pharmaceutical, chemical, environmental, food, agricultural or related disciplines. But also proteins and peptides may be contemplated as targets for MIPs. Depending on the nature of the target, templates and monomers for the molecularly imprinted polymers are accordingly designed. The ordinary person skilled in the art may choose appropriate monomers, cross-linkers, porogenic systems, initiator systems and other components to suit the imprinted polymer to be produced. Likewise, the continuous phase has to be adapted to the chosen imprinting mixture. For example, if the imprinting mixture displays hydrophilic properties, the continuous phase could consist of any hydrophobic solvent, paraffin or other long-chain alkanes such as heptane, chlorinated or/and fluorinated solvents, FCKWs, subcritical or supercritical fluids or any other appropriate liquid phase that may be envisaged for that process. By contrast, if the overall nature of the monomer mixture is hydrophobic, the nature of the continuous phase may then be polar and/or hydrophilic. Known and popular continuous phases are based on water, aqueous buffers, PVA, gelatin or starch solutions. There may of course be other hydrophilic phases not mentioned here that would be equally applicable.

For the purpose of clarification, molecularly imprinted materials can be based on organic monomers, such as styrenic and acrylic monomers and also on inorganic molecules such as silanes. These same materials can be acidic, basic, neutral, hydrophobic, hydrophilic, coordinative in nature, or any combination thereof. Interactions of the imprinted material or the monomers with the target and the analyte can be covalent, semi-covalent or non-covalent in nature or modifications or combinations thereof.

As widely described, porogens of imprinted materials are often aprotic organic solvents, but they can also be polar aqueous solvents or other porogenic agents or combinations thereof. If desired, a second, or third and so on porogenic solvent could be added to the system to create further classes of pore size populations. For example, long-chain alcohols or alkanes, such as octanol or dodecane could be used. Other porogenic agents may be used to further engineer the porosity characteristics of the imprinted materials. Such agents may include particulates, porous or solid silica and supercritical or subcritical fluids, glymes of various chemistries (diglyme, butylglyme, etc.), short or long soluble polymers e.g. polystyrene or polyacrylates, or inorganic crystals, such as sodium chloride or similar that can be dissolved away after bead formation.

As used herein the term “imprinting mixture” is a solution containing at least one monomer, optionally also being a crosslinker, optionally at least one cross-linker, optionally at least one solvent, at least one template and at least one type of initiator. Imprinting mixture, monomeric solution monomer mixture are used interchangeably herein. MIP droplets are droplets formed from the imprinting mixture. MIP beads are obtained by polymerization of MIP droplets.

As used herein MIP beads, molecularly imprinted polymer bead particles and molecularly imprinted polymer resin are used interchangeably.

As used herein the term “membrane” means any membrane having a controlled pore size and being capable of forming droplets of an imprinting mixture. Non-limiting example of suitable membranes are ceramic, polymeric, metallic membranes, or emulsification membranes. A preferred membrane is a Shirasu porous glass membrane.

An important factor is the continuous phase into which the monomeric solution (imprinting mixture) is dispersed. Depending on the nature of the monomeric solution, the continuous phase can be a highly polar water solution if the monomers are predominantly hydrophobic and hence poorly soluble or insoluble in water. Likewise, if the monomer solution is of a more polar nature, the continuous phase may be a hydrophobic alkane, a chlorinated or otherwise halogenated solvent, a supercritical or subcritical fluid or any other hydrophobic solvent. In order to increase the integrity of the dispensed monomer droplets, hydrocolloids or other protective polymers such as polyvinyl alcohol, gelatin or starch can be used as additives in the continuous phase. In inverse systems, similar surface active compounds can be employed. Also, viscous co-solvents can be admixed to the continuous phase in order to protect the integrity of the monomer droplets.

In a further embodiment of the invention, the liquid monomer phase is pressed through a polymer membrane, a porous glass material, or a porous ceramic or metallic material. These materials may be in the form of membranes of various geometries, sheets, discs or foils, as non-limiting examples. In these processes, the formed droplets are transported by a cross-flow of the continuous phase. By such methods, the process is amenable to large-scale production of such monodisperse beads. Using such methods in either batch or continuous mode, the MIP bead size and size distribution are able to be accurately and reproducibly controlled. Furthermore, such a process will be more efficient and economical than the stirred systems currently in use, particularly when used for process scale production.

The molecularly imprinted polymer resin according to the invention provides several improvements compared to the above mentioned prior art, i.e. broad particle size distribution, granular shape, and low yield of the above described synthesis process (monolith approach) in which polymer grinding leads to non-uniform granules of varying size and shape (poor particle morphology), and involves laborious work-up steps and leads to poor control of process parameters and low yield.

The invention will now be illustrated by way of examples, which examples are not to be considered as limiting to the present invention.

### EXAMPLE 1

### Nozzle Bead Formation

A monomer mixture consisting of 1 mmol atrazine, 4 mmol methaciylic acid, 0.5 mmol azoisobutyronitrile and 20 mmol ethyleneglycol dimethacrylate and toluene as solvent. After complete dissolution of the components, the mixture is bubbled with nitrogen for 5 minutes. A continuous phase is prepared consisting of water containing 2% polyvinylalcohol. The monomer mixture is forced through a tiny orifice in the form of an injection nozzle where it disintegrates into small droplets. These droplets then enter into the continuous phase and the continuous phase is heated to 65° C. and the droplets of the monomer mixture polymerize to MIP beads. The MIP beads obtained are uniform and spherical.

### EXAMPLE 2

### Cross Membrane Emulsification

A monomer mixture is prepared consisting of 1 mmol atrazine, 4 mmol methacrylic acid, 0.5 mmol azoisobutyronitrile and 20 mmol ethyleneglycol dimethacrylate and toluene as solvent. After complete dissolution of the components, the mixture is bubbled with nitrogen for 5 minutes. A continuous phase is prepared consisting of water containing 2% polyvinylalcohol. The monomer mixture is forced through a porous membrane tube and droplets formed are continuously transported by a cross-flow of the continuous phase and the continuous phase is heated to 65° C. and the droplets of the monomer mixture polymerize to MIP beads. The MIP beads obtained are uniform and spherical.

### EXAMPLE 3

A molecularly imprinted polymer monomer mixture is prepared consisting of 1 mmol atrazine, 4 mmol methacrylic acid, 0.5 mmol azoisobutyronitrile and 20 mmol ethyleneglycol dimethacrylate and toluene as solvent. After complete dissolution of the components, the mixture is bubbled with nitrogen for 5 minutes. A continuous phase is prepared consisting of water containing 2% polyvinylalcohol. The imprinting mixture is taken up with a dispensing device (e.g. Mini kit K-125 from SPG Technology, Japan) and pressed through a controlled pore membrane into the continuous phase. Then the continuous phase containing the monomer droplets of the mixture is heated to 65° C. and the droplets of the monomer mixture polymerize to MIP beads The MIP beads obtained are uniform and spherical.

1. A molecularly imprinted polymer resin obtainable by
a) providing a continuous phase,
b) providing at least one monomer and at least one template, optionally in a solvent, forming an imprinting mixture, being mainly immiscible in said continuous phase,
c) providing a porous membrane, separating said continuous phase and said imprinting mixture,
d) allowing said imprinting mixture to pass through said porous membrane, forming droplets in said continuous phase,
d) polymerizing said imprinting mixture,
e) removing said continuous phase and said template to obtain said molecularly imprinted polymer resin.

2. Molecularly imprinted polymer resin according to claim 1, wherein said membrane is a controlled pore size membrane.

3. Molecularly imprinted polymer resin according to claim 2, wherein said membrane is a shirasu porous glass membrane.

4. Molecularly imprinted polymer resin according to claim 3, wherein the monomer or crosslinker comprise silanes, acrylic, vinylic or styrenic functionalities.

5. Molecularly imprinted polymer resin produced according to claim 4 using radical, condensation, ring-opening, living polymerization.

6. Molecularly imprinted polymer resin according to claim 5, wherein said resin is obtained in the presence of a porogen, a mixture of porogens, solid particulates, soluble macromolecules, or stabilizers.

7. Molecularly imprinted polymer resin according to claim 6, said resin having a monodisperse particle size distribution in the range 5-500 μm.

8. Molecularly imprinted polymer resin according to claim 7, wherein said molecularly imprinted polymer resin is chemically modified at the polymer backbone or surface modified by chemical modification of residual silane, vinyl or acryl groups or by cleavage of non-polymerized acrylic esters.

9. Use of a molecularly imprinted polymer resin according to claim 1, as stationary phases in liquid chromatography, batch separations, sensor applications, controlled release materials, catalysts, biomimetic materials, thermodynamic traps and entrapment matrices.

10. Use of a molecularly imprinted polymer resin according to claim 1, as stationary phases in the separation of chemicals, metal ions, inorganic compounds, drugs, peptides, proteins, DNA, natural and artificial polymers, natural or artificial compounds, food or pharma components, virus, bacteria, cells and other entities.

11. Use of a shirasu porous glass membrane for producing a molecularly imprinted polymer resin according to claim 1.

12. A method for preparing a molecularly imprinted polymer resin comprising
providing a continuous phase,
providing at least one monomer and at least one template, optionally in a solvent, forming an imprinting mixture, being mainly immiscible in said continuous phase,
providing a porous membrane, separating said continuous phase and said imprinting mixture,
allowing said imprinting mixture to pass through said porous membrane, forming droplets in said continuous phase,
polymerizing said imprinting mixture,
removing said continuous phase and said template to obtain said molecularly imprinted polymer resin.

13. The molecularly imprinted polymer resin according to claim 1, wherein the monomer or crosslinker comprise silanes, acrylic, vinylic or styrenic functionalities.

14. The molecularly imprinted polymer resin produced according to claim 1, using radical, condensation, ring-opening, living polymerization.

15. The molecularly imprinted polymer resin according to claim 1, wherein said resin is obtained in the presence of a porogen, a mixture of porogens, solid particulates, soluble macromolecules, or stabilizers.

16. The molecularly imprinted polymer resin according to claim 1, said resin having a monodisperse particle size distribution in the range 5-500 μm.

17. The molecularly imprinted polymer resin according to claim 16, wherein said molecularly imprinted polymer resin is chemically modified at the polymer backbone or surface modified by chemical modification of residual silane, vinyl or acryl groups or by cleavage of non-polymerized acrylic esters.
